(19) United States
(12) Patent Application Publication
(10) Pub. No.: US 2024/0104720 A1
(43) Pub. Date: Mar. 28, 2024

(54) RESPIRATORY PROTECTIVE DEVICE DETECTION USING OPTICAL TAGGING AND IMAGE PROCESSING

(71) Applicant: INTERNATIONAL BUSINESS MACHINES CORPORATION, Armonk, NY (US)

(72) Inventor: Thomas Guthrie Zimmerman, Cupertino, CA (US)

(21) Appl. No.: 17/952,929

(22) Filed: Sep. 26, 2022

(51) Int. Cl. G06T 7/00

(52) U.S. Cl. CPC G06T 7/0012; G06T 2207/10048; G06T 2207/30041

(57) ABSTRACT

Respiratory protective device detection using optical tagging and image processing includes receiving one or more infrared images of a user. An optical tag is detected within the one or more infrared images. The optical tag is disposed on a respiratory protective device. A notification is generated indicating that the user is wearing a respiratory protective device in response to detecting the optical tag within the one or more infrared images. Respiratory protective device detection also may include detecting eyes of the user within the one or more infrared images, determining a distance between the optical tag and the eyes of the user within the one or more infrared images, and comparing the distance with a threshold distance. The notification can indicate whether the respiratory protective device is covering a nose of the user based on the comparing.

### BACKGROUND

This disclosure relates to image processing and, more particularly, to detecting whether users are wearing respiratory protective devices and/or are properly wearing respiratory protective devices using optical tagging and image processing.

Wearing respiratory protective devices is one technique for mitigating the spread of air-borne viruses. There are many different varieties of respiratory protective devices with face masks being one example. When worn properly, respiratory protective devices can reduce the transmission of air-borne viruses. This may be particularly useful in scenarios where people gather with others in indoor environments. The air-flow within indoor environments is often less robust compared to outdoor environments making the spread of air-born viruses more likely without proper mitigation. Without properly worn respiratory protective devices and/or other mitigation techniques, droplets carrying virus may be expelled into the air and linger for a significant amount of time thereby increasing the likelihood of viral spread.

In a variety of different social, business, and/or governmental contexts, persons may be asked or even required to wear respiratory protective devices. Some users may disregard these requirements while other users may wear the respiratory protective devices but do so improperly. An example of improper respiratory protective device usage is one in which the respiratory protective device is worn so that the user's nose and, more particularly, the nostrils, are not covered by the device. This may render the respiratory protective device ineffective. Further, the many different types of respiratory protective devices available in the marketplace vary widely in terms of effectiveness in mitigating air-borne viral transmission. Thus, simply wearing any respiratory protective device may not provide sufficient mitigation of viral spread.

### SUMMARY

In one or more embodiments, a method includes receiving one or more infrared images of a user. The method includes detecting, using image processing circuitry, an optical tag within the one or more infrared images. The optical tag is disposed on a respiratory protective device. The method includes, in response to detecting the optical tag within the one or more infrared images, generating a notification indicating that the user is wearing the respiratory protective device.

In one or more embodiments, a system includes an infrared camera configured to capture one or more infrared images of a user. The system includes an image processing circuitry coupled to the infrared camera. The image processing circuitry is configured to perform operations. The operations include detecting an optical tag within the one or more infrared images. The optical tag is disposed on a respiratory protective device. The operations include, in response to detecting the optical tag within the one or more infrared images, generating a notification indicating that the user is wearing a respiratory protective device.

In one or more embodiments, a computer program product includes a computer readable storage medium having program code stored thereon. The program code is executable by a processor to initiate executable operations. The executable operations include receiving one or more infrared images of a user. The executable operations include detecting an optical tag within the one or more infrared images. The optical tag is disposed on a respiratory protective device. The executable operations include, in response to detecting the optical tag within the one or more infrared images, generating a notification indicating that the user is wearing a respiratory protective device.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example implementation of a system capable of detecting respiratory protective device usage by a user.

FIG. 2 is a front view of an example implementation of the system of FIG. 1.

FIG. 3 illustrates an example method of operation of the system of FIG. 1.

FIG. 4 illustrates another example method of operation of the system of FIG. 1.

FIG. 5 illustrates another example method of operation of the system of FIG. 1.

FIG. 6 illustrates an example of an infrared (IR) image captured using an on-axis IR light source.

FIG. 7 illustrates an example of an IR image captured using an off-axis IR light source.

FIG. 8 illustrates another example of an IR image captured using an on-axis IR light source.

FIG. 9 illustrates another example of an IR image captured using an off-axis IR light source.

FIG. 10 illustrates a difference IR image created by taking a difference between two IR images.

FIG. 11 illustrates another difference IR image created by taking a difference between two IR images.

FIG. 12 illustrates example features determined by the system of FIG. 1 from IR images.

FIG. 13 illustrates example features determined by the system of FIG. 1 from IR images.

FIG. 14 illustrates an example of a difference IR image in which no optical tag is detected.

FIG. 15 illustrates another example method of operation of the system of FIG. 1.

FIG. 16 illustrates an example of a computing system communicatively linked to the system of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to image processing and, more particularly, to detecting whether users are wearing respiratory protective devices and/or are properly wearing respiratory protective devices using optical tagging and image processing. In accordance with the inventive arrangements described within this disclosure, a respiratory protective device may have an optical tag disposed thereon. A system is capable of capturing one or more infrared (IR) images of a user. The IR images may include the face of the user. Using image processing, the system is capable of determining whether a user is wearing a respiratory protective device based on whether the optical tag, being disposed on the respiratory protective device, is detected within the IR image(s). The system is also capable of determining whether the user is wearing the respiratory protective device properly by detecting the eyes of the user within the IR image(s) and ascertaining proximity of the optical tag to the user's eyes within the IR image(s).

For example, the system is capable of determining a distance between the optical tag and the eyes of the user within the IR image(s). The system can compare the distance between the optical tag and the user's eyes with a threshold distance. Based on the comparison, the system is capable of determining whether the user is wearing the respiratory protective device properly. More particularly, the system is capable of making a determination as to whether the respiratory protective device, as worn by the user, is covering the nose of the user based on the distance between the optical tag and the user's eyes as compared to the threshold distance. Within this disclosure, a respiratory protective device that is covering the user's nose is covering the user's nostrils. A properly worn respiratory protective device is one that is covering the user's nose. An improperly worn respiratory protective device is one that is not covering the user's nose.

The inventive arrangements may be used to automatically detect and determine (e.g., report) user compliance with respiratory protective device usage requirements. Further, the inventive arrangements are capable of detecting user compliance in wearing approved or selected respiratory protective devices as opposed to users choosing to wear unapproved respiratory protective devices that do not have an optical tag.

In addition, the inventive arrangements are capable of detecting respiratory protective device usage and/or proper respiratory protective device usage by users (e.g., compliance) in a manner that does not violate privacy concerns of users. More particularly, unlike other techniques that rely on high-resolution color video in combination with machine learning techniques that detect facial features of users and/or other distinguishing features, the inventive arrangements described within this disclosure are capable of automatically determining user compliance with respect to respiratory protective device usage using techniques that do not involve facial recognition or detecting other identifying facial features of individual users.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

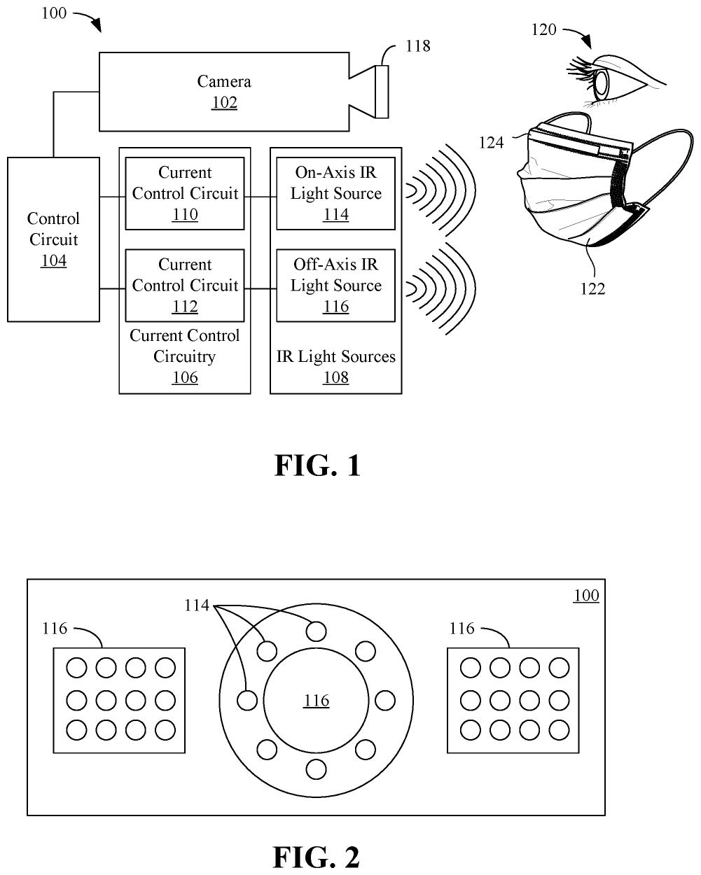

FIG. 1 illustrates an example implementation of a system 100. System 100 is capable of detecting respiratory protective device usage by a user and/or proper respiratory protective device usage by a user. In the example, system 100 includes a camera 102 coupled to a control circuit 104. Control circuit 104 also is communicatively linked to current control circuitry 106. Current control circuitry 106 is coupled to, and drives, IR light sources 108.

In the example of FIG. 1, camera 102 is a monochromatic camera characterized by capturing contrast in images based on detecting differing amounts of light as opposed to a camera that uses different colors to capture and represent an image. An example of a monochromatic camera that may be used as camera 102 is an IR camera. An IR camera is capable of generating an image using IR light (e.g., IR radiation) as opposed to visible light. For example, an IR camera is capable of detecting wavelengths from approximately 700 nm to approximately 1 um. In one or more example implementations, camera 102 is capable of generating IR images with a resolution of 800×600 pixels. In other examples, the resolution of the IR images generated by camera 102 may be greater than or lesser than the example provided. In one aspect, camera 102 may be an IR video camera capable of capturing a plurality of frames, where each frame may be considered a different IR image.

In the example of FIG. 1, current control circuitry 106 includes current control circuit 110 and current control circuit 112. Each current control circuit 110, 112 is capable of driving a different IR light source of the IR light sources 108. For example, current control circuit 110, operating under control of control circuit 104, is capable of providing current to, or driving, on-axis IR light source 114. Current control circuit 112, operating under control of control circuit 104, is capable of providing current to, or driving, off-axis IR light source 116. An example of on-axis IR light source 114 includes one or more IR Light Emitting Diodes (LEDs). Similarly, an example of off-axis IR light source 116 includes one or more IR LEDs.

In one aspect, control circuit 104 may be implemented as dedicated or hardened circuitry. In another aspect, control circuit 104 may be implemented as a processor that is capable of executing computer-readable program instructions. Control circuit 104 may include memory for storing and/or processing one or more IR images as captured by camera 102. Control circuit 104 is capable of causing current control circuit 110 to provide sufficient current to on-axis IR light source 114 to activate on-axis IR light source 114 and to discontinue providing current to on-axis IR light source 114 to deactivate on-axis IR light source 114. In addition, control circuit 104 may cause current control circuit 110 to provide a variable amount of current to on-axis IR light source 114 over time and/or under different circumstances. Similarly, control circuit 104 is capable of causing current control circuit 112 to provide sufficient current to off-axis IR light source 116 to activate off-axis IR light source 116 and to discontinue providing current to off-axis IR light source 116 to deactivate off-axis IR light source 116. In addition, control circuit 104 may cause current control circuit 112 to provide a variable amount of current to off-axis IR light source 116 over time and/or under different circumstances.

Control circuit 104 is also capable of controlling operation of camera 102. For example, control circuit 104 is capable of causing camera 102 to capture an IR image concurrently with activation of on-axis IR light source 114 and/or off-axis IR light source 116. As such, IR light transmitted into the field of view of camera 102 by IR light sources 108 that is reflected back toward camera 102 may be captured by camera 102, e.g., the optics thereof, to create IR images. Control circuit 104 also is capable of causing camera 102 to capture an IR image without activating either one of on-axis IR light source 114 or off-axis IR light source 116.

In one or more example implementations, camera 102 is outfitted with a filter 118. Filter 118 may be a visible light blocking filter. That is, filter 118 may be configured to block visible light. For example, filter 118 is capable of preventing visible light from entering the optics of camera 102. Further, filter 118 is capable of allowing IR light to pass, e.g., into the optics of camera 102. Filter 118 may be configured or tuned to allow IR light of a particular wavelength or range of wavelengths to pass. For purposes of illustration and not limitation, filter 118 may allow IR light of 850 nm or of approximately 850 nm to pass. Use of filter 118 may enhance the visibility of certain features in IR images captured by camera 102. For example, use of filter 118 may cause the eyes of a user and an optical tag that may be applied to a respiratory protective device to be detected with greater ease (e.g., less image processing and/or using less computational resources) than would otherwise be the case. Filter 118, for example, increases the IR return signal from the retina of the user's eye and of optical tag 124.

In the example of FIG. 1, a user 120 is wearing a respiratory protective device 122. An optical tag 124 is disposed on respiratory protective device 122. Within this disclosure, the term “disposed,” in reference to optical tag 124, may mean applied, integrated or embedded within or as part of, or otherwise attached. In an example implementation, optical tag 124 is implemented as a strip of retro-reflective material. For example, the retro-reflective material may be retro-reflective tape that may be disposed on respiratory protective device 122 using adhesive, sewn on, or by another suitable attachment technique. Another example of a retro-reflective material that may be used to form optical tag 124 includes retro-reflective glass beads. A material or device that is retro-reflective is one that reflects particular forms of radiation (e.g., light such as IR light in this example) back to a source. Depending on the type of material used to form optical tag 124, optical tag 124 may be applied to respiratory protective device 122 (e.g., retro-reflective tape) or embedded in a layer (e.g., a top layer) of respiratory protective device 122. In the examples, optical tag 124 is disposed on respiratory protective device 122 using an attachment technique as described herein.

Optical tag 124 may be disposed on respiratory protective device 122 along a top edge that is intended to cover or be located above the user's nose (e.g., nostrils). Optical tag 124 may be flexible to conform to the shape of the user's face and nose when respiratory protective device 122 is worn by the user. In other arrangements, depending on the type of respiratory protective device 122 used, the optical tag may be placed at another location so long as the location of the optical tag with respect to the particular respiratory protective device used is known to system 100.

In the example of FIG. 1, one or more IR images captured using system 100 may be analyzed using image processing to detect certain features in the IR images. Control circuit 104, which is an example of image processing circuitry, may perform the image processing operations. The features extracted or detected from the IR image(s) may include optical tag 124 (e.g., IR light reflected back to camera 102 from optical tag 124) and the eyes of the user (e.g., IR light reflected back to camera 102 from the retinas of the user).

In one or more examples, respiratory protective device 122 may be a selected type of device. The selected type of device may be one that has been selected or certified by an organization as providing a minimum amount of protection from air-borne viruses. The organization may distribute the selected type of device to users and/or members for use with optical tag 124 disposed thereon. In the example, respiratory protective device 122 may be a face mask having a minimum number of layers (e.g., 1, 2, 3, or more layers). The layers may be made of selected materials. In other examples, respiratory protective device 122 may be another type of device or mask with varying numbers and/or types of layers if deemed to provide sufficient protection from air-borne viruses.

In the example of FIG. 1, the attachment of optical tag 124 to respiratory protective device 122 serves as a mechanism to differentiate an approved or selected type of respiratory protective device from one that is not selected or approved. Those respiratory protective devices without an optical tag 124 may not be detected by system 100 and lead system 100 to determine that no mask is present or being worn by a user. Thus, the use of optical tag 124 also allows system 100 to detect whether particular types of respiratory protective devices (e.g., those that have been pre-approved) are being worn and/or used properly. By comparison, other systems that rely on high-resolution color images are unable to adequately distinguish one type of respiratory protective device from another (e.g., one type of mask from another). In one or more examples, optical tag 124 may be applied to only respiratory protective devices having a known, minimum quality to ensure a constant or minimum standard of effectiveness.

The use of an optical tag for detecting respiratory protective device usage compliance also allows system 100 to operate without the need to detect identifying facial features of users or performing facial recognition on captured images. Further, system 100 is capable of operating accurately using low-resolution images in contrast to other techniques that rely on high-resolution color images. For example, camera 102 may generate IR images with resolutions of approximately 800×600 pixels with system 100 being capable of accurately detecting respiratory protective device usage compliance. In one or more examples, an image that captures a head of a user in a region of the image of approximately 24×24 pixels is sufficient to detect optical tag 124 and/or the eyes of the user to implement the techniques described herein.

In general, the eyes of people looking towards camera 102 will cause strong IR reflections, also known as the “red eye” effect, as the co-located illumination reflects off the subject's retina. Optical tag 124 applied to respiratory protective device 122 also returns a strong IR reflection. Filter 118 causes camera 102 to primarily capture eyes and optical tags. With several users in the field of view of camera 102 and within a particular distance, for example, an IR image will show, for each user wearing a selected respiratory protective device, a set of eyes with a line below where the line corresponds to the optical tag.

In one or more example implementations, system 100 is capable of detecting whether a user is wearing a respiratory protective device 122 at distances of up to approximately 200 feet. System 100 is capable of determining whether a user is wearing respiratory protective device 122 properly at distances of up to approximately 10 feet. It should be appreciated that increasing the current provided to IR light sources 108 may increase the operable range of system 100 for detecting whether a user is wearing a respiratory protective device 122 and/or for determining whether a user is wearing a respiratory protective device 122 properly.

FIG. 2 is a front view of an example implementation of system 100. In the example of FIG. 2, system 100 includes on-axis light source 114 and off-axis IR light source 116 shown relative to filter 118, which may be disposed in front of the lens(es) and/or optics of camera 102. In the example, individual elements of on-axis IR light source 114 surround the lens of camera 102. Individual elements of off-axis IR light source 116 are farther away from the lens of camera 102 on each side. In this example, the elements of on-axis IR light source 114 and the elements of off-axis IR light source 116 may be IR LEDs.

FIG. 2 is provided for purposes of example only to illustrate the relative placement of elements of on-axis IR light source 114 compared to elements of off-axis IR light source 116. It should be appreciated that system 100 may be implemented in other form factors and/or configurations. For purposes of illustration, IR light sources 108 are capable of generating IR light of approximately 850 nm. Appreciably, IR light sources 108 may be configured to generate IR light in other portions of the IR spectrum. As such, the particular wavelength(s) noted within this disclosure are provided as examples and not limitations. Appreciably, the IR light generated by IR light sources 108 will be matched to the pass-band of filter 118.

In one or more example implementations, system 100 is capable of capturing an IR image with IR light sources 108 deactivated (e.g., with both of on-axis IR light source 114 and off-axis IR light source 116 turned off). System 100 is also capable of capturing an IR image with on-axis IR light source 114 activated (e.g., turned on) and off-axis IR light source 116 deactivated (e.g., turned off). System 100 is also capable of capturing an IR image with on-axis IR light source 114 deactivated and off-axis IR light source 116 activated. The IR images may be captured in rapid succession. For example, the IR images may be captured sequentially or within a predetermined amount of time of one another (e.g., within a second) so that the IR images may be substantially similar in terms of content and compared. For example, two or more or all of the IR images may be sequential frames of video, non-sequential frames of video captured within a predetermined amount of time of one another, or IR images captured within a predetermined amount of time of one another.

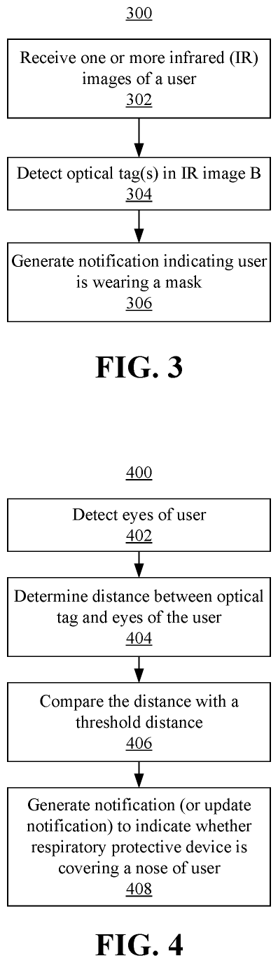

FIG. 3 illustrates an example method 300 of operation of system 100 of FIGS. 1 and 2. In block 302, system 100 receives one or more IR images of a user. The IR images may be captured by camera 102. The IR image(s) that are captured will include the face of the user. For example, control circuit 104, is capable of causing camera 102 to capture IR images concurrently or in synchronization with activating certain ones of IR light sources 108 and/or without activating any of IR light sources 108. The one or more IR images may be received by control circuit 104 (or another system coupled to system 100 as described hereinbelow) for further processing. Also in block 302, the IR image(s) may be captured by camera 102 using filter 118.

In block 304, system 100 is capable of detecting, using image processing, an optical tag within the one or more IR images. For example, control circuit 104 is capable of detecting a region corresponding to the reflection of optical tag 124 within the one or more IR images. As noted, optical tag 124 is disposed on respiratory protective device 122.

In one or more example implementations, objects, e.g., optical tags, user heads, and/or eyes, may be detected within the IR images described herein using any of a variety of available image processing and/or object detection techniques. Such techniques, for example, are capable of detecting a contour or boundary of an object within an image and determining whether a shape formed of that contour and/or boundary has particular features to identify the type of object found. For example, the perimeter, circularity, and/or other features may be evaluated to identify the object as an optical tag, a head of a user, or an eye.

In block 306, in response to detecting optical tag 124 within the one or more IR images, system 100 is capable of generating a notification indicating that the user is wearing a mask. In one or more example implementations, system 100 is capable of providing the notification to another system and/or device communicatively linked thereto. For example, system 100 may send a notification (e.g., email, text message, or other electronic communication) to another computing system that maintains respiratory protective device compliance data. In another example, the notification may be displayed on a display device as a visual message (e.g., using a graphical user interface) or audibly played via a sound generating device.

As discussed, system 100 is capable of detecting whether a user is wearing a mask as described in connection with FIG. 3 in cases where the user is up to approximately 200 feet away from camera 102. Further, system 100 may do so accurately while using lower resolution images as previously discussed without employing facial recognition technology.

FIG. 4 illustrates another example method 400 of operation of system 100 of FIGS. 1 and 2. Method 400 may be performed in combination with method 300 of FIG. 3. For example, method 400 may be performed following one or more operations of method 300 (e.g., blocks 304 and/or 306). In another aspect, method 400 may be performed independently of method 300 presuming one or more IR images have been captured and received by control circuit 104 as previously described.

In block 402, system 100 detects the eyes of the user within the one or more IR images. In block 404, system 100 determines a distance between optical tag 124 as detected in the one or more IR images and the eyes of the user as detected in the one or more IR images. In block 406, system 100 compares the distance with a threshold distance. In block 408, system 100 generates a notification or updates the notification of block 306 to indicate whether respiratory protective device 122 is covering the user's nose. As noted, a respiratory protective device found to cover the user's nose (e.g., nostrils) is considered to be worn properly, whereas a respiratory protective device found not to cover the user's nose (e.g., nostrils) is considered to be worn improperly.

In the examples of FIGS. 3 and 4, the image processing may be performed on an IR image captured with only on-axis IR light source 114 activated, or with only off-axis IR light source 116 activated, or with both on-axis IR light source 114 and off-axis IR light source 116 activated.

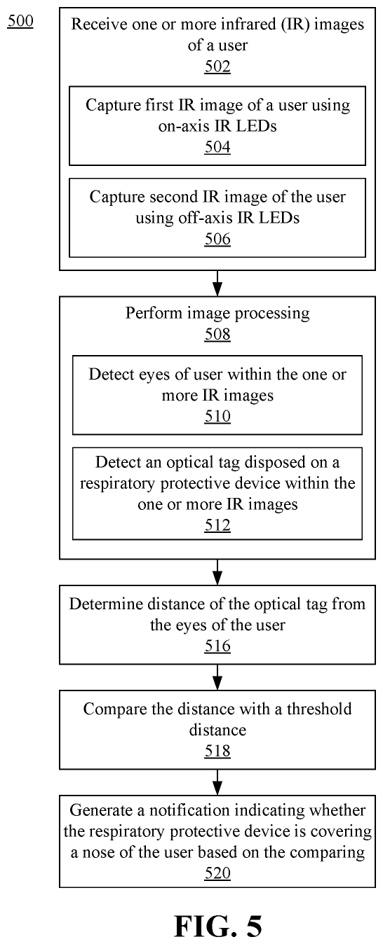

In one or more other example implementations, the image processing performed in FIGS. 3 and/or 4 may be performed using a differencing technique applied to captured IR images as described in greater detail in connection with FIG. 5.

FIG. 5 illustrates another example method 500 of operation of system 100 of FIGS. 1 and 2. In general, method 500 illustrates example techniques for detecting eyes within IR images and for determining whether a user is wearing respiratory protective device 122 properly.

In block 502, system 100 receives one or more IR images of a user. The IR images may be captured by camera 102. The IR images that are captured will include the face of the user. For example, control circuit 104, is capable of causing camera 102 to capture IR images concurrently or in synchronization with activating certain ones of IR light sources 108. The one or more IR images may be received by control circuit 104 (or another system as described hereinbelow) for further processing. Also in block 502, the IR image(s) may be captured by camera 102 using filter 118.

In one aspect, block 502 includes blocks 504 and 506. In block 504, system 100 captures a first IR image of the user using on-axis IR light source 114. More specifically, in block 504, control circuit 104 activates on-axis light source 114 concurrently with deactivating off-axis IR light source 116 and causing camera 102 to capture a first IR image. As such, the IR light captured in the first IR image includes IR light generated by on-axis IR light source 114 that is reflected back to camera 102. At close range (e.g., distances of up to approximately 10 feet between camera 102 and the user), the retina of a user's eye returns a strong signal using on-axis IR light source 114. Similarly, at close range, a strong signal is returned from optical tag 124 using on-axis IR light source 114.

The strong signals returned mean that image processing may be performed while using reduced computational resources. This means that the image processing may be performed directly within system 100 by control circuit 104. The reduced set of computational resources needed to process the captured images reduces the need for a centralized processing system to perform image processing. Further, performing image processing locally within system 100 (e.g., using control circuit 104) reduces network data traffic since the captured IR images need not be transmitted to another system for processing.

Facial features and/or other details of the users, in comparison to the user's eyes and/or optical tag 124, return weak signals. Such facial features do not reflect IR as efficiently as the user's eyes and/or the optical tag 124. This helps to protect privacy of individuals in that the use of facial recognition technology in determining user compliance in wearing respiratory protective devices becomes infeasible using the IR images.

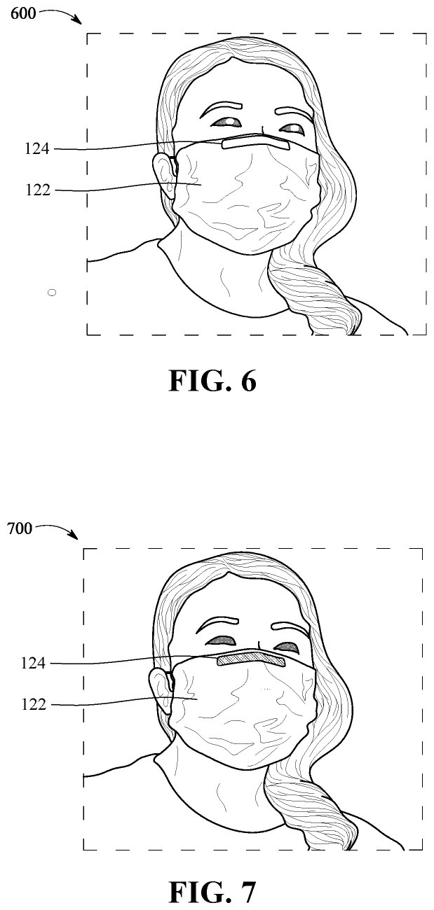

FIG. 6 illustrates an example of an IR image 600 captured using on-axis IR light source 114. In the example of FIG. 6, the user is wearing respiratory protective device 122 having an optical tag 124 disposed thereon. The example of FIG. 6 illustrates a case where respiratory protective device 122, as worn by the user, is covering the user's nose. The user's nostrils are covered by respiratory protective device 122. FIG. 6 illustrates proper use of the respiratory protective device. In IR image 600, IR light is reflected off of the user's retinas rendering them visible. Also, IR light is reflected off of optical tag 124 rendering it visible. Both the retinas and optical tag 124 are shown white to illustrate the high degree of visibility within IR image 600.

As a general matter, optical tag 124 appears curved in nature as optical tag 124 may be flexible to curve around the shape/contour of the user's nose. The curvature of optical tag 124 provides improved visibility of optical tag 124 as the user's head rotates relative to camera 102. For example, optical tag 124 may be detectable in an IR image whether the user is facing camera 102, is in side profile, or any variation therebetween.

In block 506, system 100 captures a second IR image of the user using off-axis IR light source 116. More specifically, in block 506, control circuit 104 activates off-axis IR light source 116 concurrently with deactivating on-axis IR light source 114 and causing camera 102 to capture a second IR image. As such, the IR light captured in the second IR image includes IR light generated by off-axis IR light source 116 that is reflected back to camera 102. At close range, the retina and optical tag 124 return a weak signal using off-axis IR light source 116. Correspondingly, facial features and/or other details of the user return even weaker signals.

FIG. 7 illustrates an example of an IR image 700 captured using off-axis IR light source 116. In the example of FIG. 7, the user is wearing respiratory protective device 122 having an optical tag 124 disposed thereon. The example of FIG. 7 illustrates a case where respiratory protective device 122, as worn by the user, is covering the user's nose. The user's nostrils are covered by respiratory protective device 122. FIG. 7 illustrates proper use of the respiratory protective device. In IR image 700, IR light is not reflected off of the user's retinas rendering them virtually invisible in image 700. Also, while IR light is reflected off of optical tag 124, a lesser amount of IR light reflects compared to the example of IR image 600.

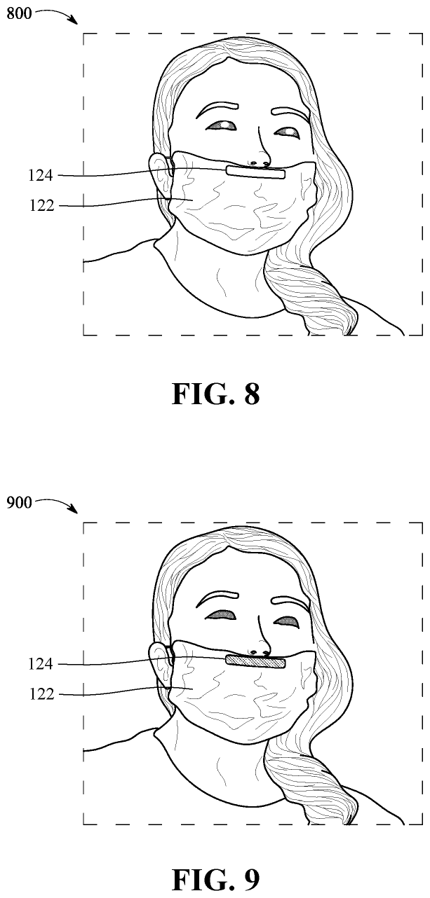

FIG. 8 illustrates an example of an IR image 800 captured using on-axis IR light source 114. In the example of FIG. 8, the user is wearing respiratory protective device 122 having optical tag 124 disposed thereon. The example of FIG. 8 illustrates a case where respiratory protective device 122, as worn by the user, is not covering the user's nose. The user's nostrils are not covered by respiratory protective device 122. FIG. 8 illustrates an example of improper usage of the respiratory protective device. In IR image 800, IR light is reflected off of the user's retinas rendering them visible. Also, IR light is reflected off of optical tag 124 rendering it visible. Both the retinas and optical tag 124 are shown white to illustrate the high degree of visibility within IR image 800.

FIG. 9 illustrates an example of an IR image 900 captured using off-axis IR light source 116. In the example of FIG. 9, the user is wearing respiratory protective device 122 having optical tag 124 disposed thereon. The example of FIG. 9 illustrates a case where respiratory protective device 122, as worn by the user, is not covering the user's nose. The user's nostrils are not covered by respiratory protective device 122. FIG. 9 illustrates an example of improper usage of the respiratory protective device. In IR image 900, IR light is not reflected off of the user's retinas rendering them virtually invisible in image 900. Also, while IR light is reflected off of optical tag 124, a lesser amount of IR light reflects compared to the example of IR image 800.

In block 508, system 100 performs image processing. For example, in block 510, system 100 is capable of detecting eyes (e.g., pupils) of the user in the IR images by performing image processing. In block 512, system 100 is capable of detecting an optical tag disposed on the respiratory protective device within the IR images. System 100 is capable of using any of a variety of known image processing techniques to detect the eyes of the user within the captured IR images and to detect optical tag 124 within the IR images.

In one or more examples, the image processing performed by system 100 in block 508 to detect the eyes of the user and to detect optical tag 124 is implemented by control circuit 104 taking a difference between the first IR image of block 504 and the second IR image of block 506. By taking the difference between the first and second IR images, the location of each eye of the user and the location of optical tag 124 may be determined by system 100.

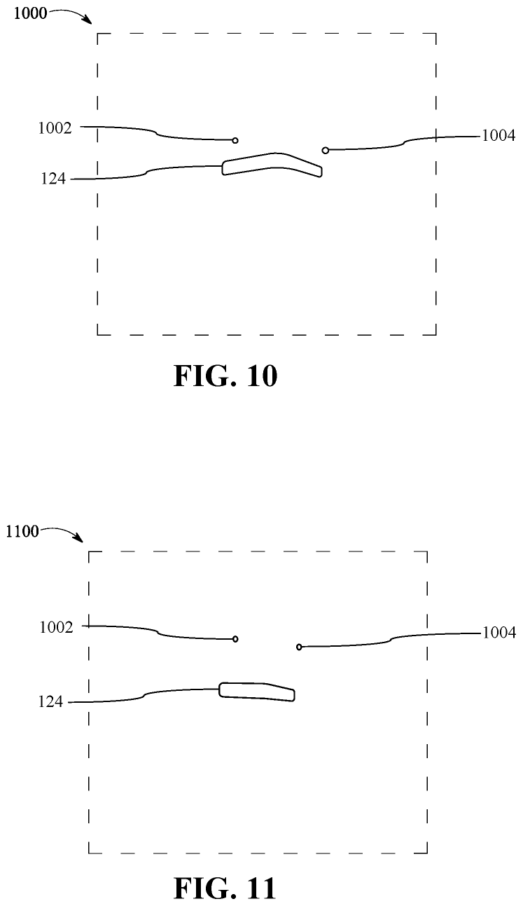

FIG. 10 illustrates a difference IR image 1000 created by taking a difference between two IR images. FIG. 10 illustrates an example result of the image processing performed by system 100 in taking a difference between the IR image of FIG. 6 and the IR image of FIG. 7. FIG. 10 illustrates the high contrast nature of difference IR image 1000, which allows system 100 to detect the user's eyes and the optical tag and further to determine locations of each. The image processing on difference IR image 1000 requires a lesser amount of computational resources in view of the high contrast achieved. The differencing performed effectively removes nearly all detail except for the eyes and the optical tag. As shown, pupils 1002, 1004 of the user's eyes are illustrated as two white dots. The eyes are positioned above the generally horizontal feature which system 100 has identified as optical tag 124. In an actual difference IR image, the background (e.g., the portions other than those identified as the eyes and the optical tag) would appear black.

FIG. 11 illustrates another difference IR image 1100 created by taking a difference between two IR images. FIG. 11 illustrates an example result of the image processing performed by system 100 in taking a difference between the IR image of FIG. 8 and the IR image of FIG. 9. FIG. 11 illustrates the high contrast nature of difference IR image 1100, which allows system 100 to detect the user's eyes and the optical tag and further to determine locations of each using fewer computation resources. As shown, pupils 1002, 1004 of the user's eyes are illustrated as two white dots. The eyes are positioned above the generally horizontal feature which system 100 has identified as optical tag 124. In the example of FIG. 11, the distance between the eyes of the user and optical tag 124 is larger than the distance between the eyes of the user and optical tag 124 shown in the example of FIG. 8. Again, in an actual difference IR image, the background (e.g., the portions other than those identified as the eyes and the optical tag) would appear black.

In block 516, system 100 is capable of determining a distance between optical tag 124 and the eyes of the user. In one or more examples, system 100 measures the distance from optical tag 124 to the eyes using an interpupillary line.

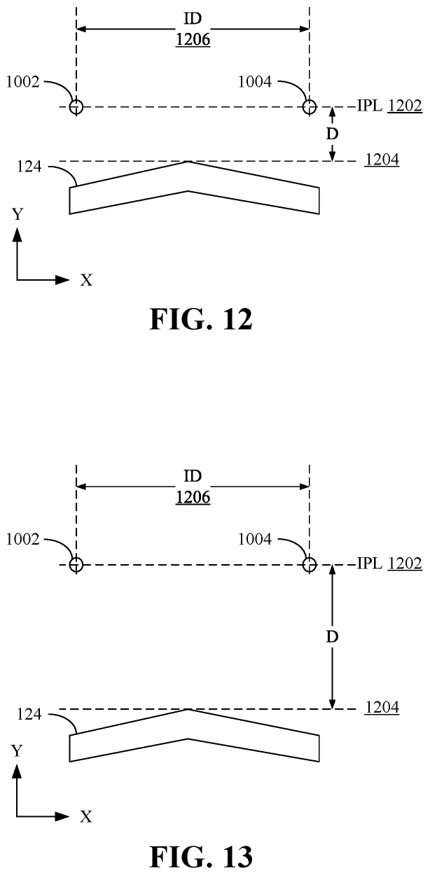

FIG. 12 illustrates an example of determining distance between the eyes of a user and optical tag 124 in an IR image. In the example of FIG. 12, the difference IR image is used for determining the features described. FIG. 12 illustrates an interpupillary line (IPL) 1202, an optical tag line 1204 indicating a location of optical tag 124, and an interpupillary distance (ID) 1206. In the example, interpupillary line 1202 is a horizontal line that is determined at a location that bisects each pupil 1002, 1004 of the user's eyes in a 2D plane. The pupils 1002, 1004 are proxies for the user's eyes. In one example, system 100 determines an X-Y coordinate for each pupil 1002, 1004 (e.g., the center thereof) from the difference between the IR images of blocks 504, 506. The location of the eyes, as used for purposes of measuring distance from the optical tag 124, may be determined to be interpupillary line 1202. System 100 also may determine the location of optical tag 124 as optical tag line 1204, e.g., a horizontal line, located at a top edge of optical tag 124.

System 100 measures the distance between the eyes of the user and optical tag 124 as illustrated in the example of FIG. 12 by determining “D,” which represents the distance between interpupillary line 1202 and optical tag line 1204. The example techniques for determining the location of the eyes of the user and the optical tag are provided for purposes of illustration and not limitation. It should be appreciated that other techniques for detecting features in image files and/or measuring distances in image files may be used in place of those described and/or in combination. In one or more example implementations, system 100 is capable of rotating the difference IR image so that pupils 1002, 1004 are along a horizontal line to establish interpupillary line 1202.

In block 518, system 100 is capable of comparing the distance D with a threshold distance. The threshold distance is used to determine whether the user is wearing respiratory protective device 122 properly, i.e., in a manner that covers the user's nose and, as such, nostrils. For example, if the distance D does not exceed the threshold, system 100 determines that respiratory protective device 122 is covering the user's nose (and nostrils) and is worn properly. If the distance D exceeds the threshold, system 100 determines that respiratory protective device 122 is not covering the user's nose (and nostrils) and is worn improperly.

In one or more examples, system 100 is capable of measuring interpupillary distance 1206, which is the distance between pupils 1002, 1004 of the user in the difference IR image. In the example of FIG. 12, with the difference IR image rotated, system 100 determines interpupillary distance 1206 as the distance between the x-coordinates of each pupil 1002, 1004 of the user (e.g., where interpupillary distance 1206=(x₂−x₁)). In other examples, the distance may be measured as D=\sqrt{(x₂−x₁)²+(y₂−y₁)²}.

In one or more example implementations, system 100 is capable of scaling the threshold distance based on interpupillary distance 1206 of the user or determining the threshold distance as a function of interpupillary distance 1206. In this regard, the threshold distance applied to each difference IR image and/or user may be specific to the particular user. For example, system 100 may calculate a ratio of interpupillary distance 1206 and D, and compare the ratio with a threshold. In one aspect, a distance D that exceeds 40% of interpupillary distance 1206 indicates that the user is wearing respiratory protective device 122 improperly. A distance D that is less than or equal to (e.g., does not exceed) 40% of interpupillary distance 1206 indicates that the user is wearing the respiratory protective device properly.

In block 520, the system is capable of generating a notification indicating whether respiratory protective device 122 is covering a nose of the user based on the comparing. For example, in response to determining that the distance does not exceed the threshold distance, system 100 determines that respiratory protective device 122 covers the nose of the user. In that case, the notification indicates that respiratory protective device 122 is worn properly by the user. FIG. 12 illustrates an example where the distance D does not exceed the threshold distance resulting in a determination that respiratory protective device 122 is covering the user's nose. In the example of FIG. 12, the distance D is approximately 25% of ID 1206. For purposes of illustration, FIG. 12 illustrates the computations performed by system 100 in processing the difference IR image of FIG. 10.

In another example, in response to determining that the distance exceeds the threshold distance, system 100 determines that respiratory protective device 122 does not cover the nose of the user. In that case, the notification indicates that the mask is not worn properly by the user. FIG. 13 illustrates an example where the distance D exceeds the threshold distance resulting in a determination that respiratory protective device 122 is not covering the user's nose. In the example of FIG. 13, the distance D is approximately 63% of interpupillary distance 1206. For purposes of illustration, FIG. 13 illustrates the computations performed by system 100 in processing the difference IR image of FIG. 11.

The use of interpupillary distance 1206 as a mechanism for setting the threshold distance allows system 100 to automatically compensate for the size of a person. That is, the threshold distance scales with the size of the person. In addition, use of interpupillary distance 1206 also allows system 100 to automatically compensate for the distance of the user from camera 102.

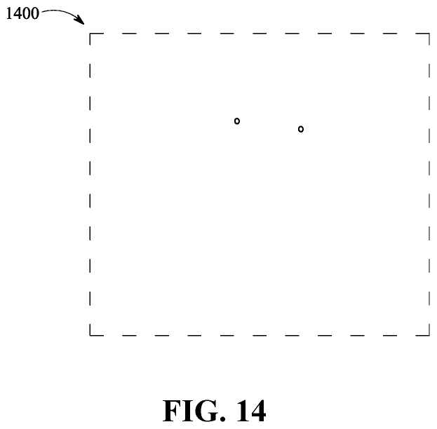

FIG. 14 illustrates an example of a difference IR image generated by system 100 in which the user is not wearing respiratory protective device 122. In the example of FIG. 14, system 100 does not detect any feature that is determined to be optical tag 124. In cases where a user is not wearing any respiratory protective device 122 or is wearing, whether correctly or incorrectly, a respiratory protective device 122 without optical tag 124 (e.g., where the respiratory protective device is not an approved device), system 100 will detect only eyes and no optical tag 124. In that case, system 100 may output a notification indicating that no mask was detected.

As discussed, system 100 is capable of providing the notification to another system and/or device communicatively linked thereto. For example, system 100 may send a notification (e.g., email, text message, or other electronic communication) to another computing system that maintains respiratory protective device compliance data. In another example, the notification may be displayed on a display device as a visual message (e.g., using a graphical user interface) or audibly played via a sound generating device.

In one or more other example implementations, system 100 may compile result data indicating compliance of users in wearing respiratory protective devices at all and/or compile data indicating compliance of users in properly wearing respiratory protective devices. The compliance data may be stored in memory for later recall or output to another system communicatively linked thereto. The compliance data, as compiled, may be displayed on a display device (e.g., using a graphical user interface) or audibly played via a sound generating device.

As discussed, the inventive arrangements described within this disclosure are capable of determining whether a user is wearing a respiratory protective device by virtue of detecting optical tag 124. For example, at longer distances, detecting the user's eye (e.g., retina) may be difficult. In such cases, system 100 is capable of determining whether a user is wearing an approved mask based on whether any optical tag 124 is detected using the same or similar image processing techniques described herein.

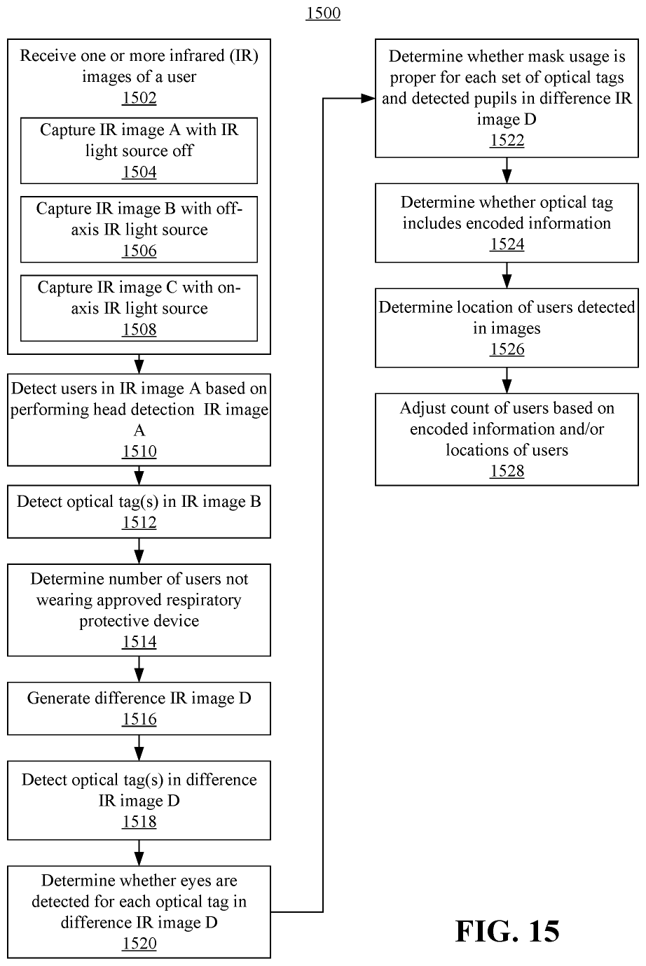

FIG. 15 illustrates another example method 1500 of operation of system 100 of FIGS. 1 and 2. The example of FIG. 15 illustrates an example implementation where the system is capable of determining whether a user is wearing a mask, whether the mask is worn correctly, proper mask usage in a population of users, and whether duplicate masks are detected.

In block 1502, system 100 receives one or more IR images. The IR images may include more than one user. The IR images may be captured by camera 102. For purposes of illustration, the IR image(s) that are captured will include one or more faces of users. For example, control circuit 104, is capable of causing camera 102 to capture IR images concurrently or in synchronization with activating certain ones of IR light sources 108 and/or without activating any of IR light sources 108. The one or more IR images may be received by control circuit 104 (or another system as described hereinbelow) for further processing. Also in block 1502, the IR image(s) may be captured by camera 102 using filter 118.

For example, in block 1504, system 100 captures an IR image A with IR light sources 108 turned off. Image A captures ambient IR light due to filter 118. In block 1506, system 100 captures an IR image B with the off-axis IR light source 116 turned on and on-axis IR light source 114 turned off. In block 1508, system 100 captures an IR image C with the off-axis IR light source 116 turned off and the on-axis IR light source 114 turned on.

In block 1510, system 100 is capable of detecting users in IR image A based on performing user head detection. For example, control circuit 104 is capable of performing a head detection image processing technique on IR image A to detect any heads of users captured in the IR image A. As a non-limiting example, a head detection technique may be an image processing shape detection technique that is capable of detecting a contour or boundary for a shape having particular features such as perimeter, circularity, and the like in an image. It should be appreciated that in the even no user heads are detected in IR image A, the method of FIG. 15 may stop or loop back to repeat (not shown).

In block 1512, system 100 is capable of detecting one or more optical tags within IR image B. For example, control circuit 104 is capable of performing a shape detection image processing technique on IR image B to detect optical tags therein. In block 1514, system 100 is capable of determining a number of the number of users not wearing an approved (e.g., optically tagged) respiratory protective device. For example, the system is capable of subtracting the number of optical tags detected in the IR image B from the number of users (e.g., user heads) detected in the IR image A resulting in the number of users not wearing an approved respiratory protective device.

In block 1516, system 100 is capable of generating a difference IR image. For example, control circuit 104 is capable of generating a difference IR image D by differencing IR image B and IR image C as previously described within this disclosure. In block 1518, control circuit 104 is capable of performing image processing to detect optical tags within the difference IR image D. In block 1520, system 100 is capable of determining whether eyes are detected for each optical tag in the difference IR image D. For example, control circuit 104 is capable of performing image processing on difference IR image D to detect user(s)'s eyes within the difference IR image D. In one aspect, system 100 is capable of determining that a given set of eyes belong to a given optical tag based on whether the eyes are detected in the difference IR image D above the optical tag within a predetermined distance (e.g., number of pixels) from the top edge of the optical tag. As an illustrative and non-limiting example, in response to determining that the distance D divided by ID 1206 is greater than 2, the system determines that the optical tag does not belong to the detected eyes. For each optical tag detected in the difference IR image D for which a corresponding set of eyes are detected, system 100 is able to make a determination of whether the user is wearing the respiratory protective device properly. Accordingly, in block 1522, for each set of an optical tag and corresponding eyes detected in the difference IR image D, system 100 is capable of applying the measurement techniques described and illustrated in connection with FIGS. 12 and 13 to make a determination as to whether that particular user is wearing the respiratory protective device properly.

In one or more other example implementations, the system 100 may perform an additional check. For example, system 100 may, in response to determining that the ID is less than a minimum distance (e.g., 4 pixels), reject difference IR image D and not provide any indication of whether a respiratory protective device is covering the nose of the user.

In block 1524, system 100 optionally determines whether the optical tag includes encoded information. In response to determining that the optical tag includes encoded information, system 100 may decode the encoded information and record the decoded information in association with any determinations made as to mask usage for the optical tag and eye pairing. The optical tag, for example, may include a bar code, QR code, or other indicia that may be read by way of control circuit 104. In this example, the encoded information may be embedded in a retro-reflective strip. The encoded information may uniquely identify the particular respiratory protective device.

In one example implementation, masks may be encoded with a unique code that is not associated with any identifying information of the user. This code allows a system to remove any duplicate counts of the mask from data that is being updated. That is, a system, whether system 100 or another system communicatively linked to system 100, may remove duplicate detections of a same respiratory protective device within a sequence of IR images based on detecting the same code within such sequence of IR images within a predetermined window or amount of time. For example, the system may determine respiratory protective device usage among a plurality of users based, at least in part, on detected optical tags. Further, the system is capable of detecting duplicate respiratory protective devices among the plurality of users based on detecting unique codes embedded in the optical tags.

In block 1526, system 100 may optionally determine locations of users detected in the one or more IR images (e.g., IR image A, IR image B, IR image C, and/or difference IR image D). In one or more example implementations, a plurality of different systems 100 may be installed at right angles to one another resulting in IR images taken orthogonally to one another. In placing multiple installations of system 100 at right angles (e.g., on 4 opposing walls of a large room), locations of individual users may be determined using triangulation techniques thereby allowing further information such as whether users are observing social distancing guidelines to be determined by system 100 or another system coupled thereto.

In block 1528, system 100 is capable of adjusting a count of users based on the image processing performed. For example, system 100 may update a count of total users detected, update a count of users not wearing masks (which may include users wearing unapproved masks that are not optically tagged), update a count of users that are wearing masks improperly, adjust a count of users wearing masks, and the like. In one aspect, system 100 is capable of adjusting the count(s) by removing duplicate detections of optical tags, based on data encoded in the optical tags, so that the resulting counts are more accurate.

In one or more example implementations, in capturing IR images, system 100 is capable of modulating the brightness of the on-axis IR light source 114 and/or off-axis IR light source 116 to compensate for distance and the smaller reflection from the user's retinas compared to the optical tag. For example, increased current may be provided to on-axis IR light source 114 to detect user's eyes.

In one or more other example implementations, the optical tag may be implemented as a QR code printed in glass beads embedded in the top layer of the respiratory protective device (e.g., mask). The location of the QR code may be used as an alternative optical tag to the horizontal strip configuration illustrated in the figures.

In one or more other example implementations, the respiratory protective device may be formed of, or have an outer layer of, retro-reflective material. For example, a mask may have such an outer layer thereby allowing system 100 to detect the respiratory protective device and determine a location of the respiratory protective device relative to the user's eyes as previously described. In this example, the entire respiratory protective device or a substantial portion thereof replaces or becomes the optical tag.

While the image processing described herein may be performed locally within system 100, in one or more other example implementations, the image processing may be performed in a different computing device. For example, system 100 may convey IR images including difference IR images to such other system(s) so that the other system may perform the image processing operations described herein, generate notifications, and/or compile the compliance data described.

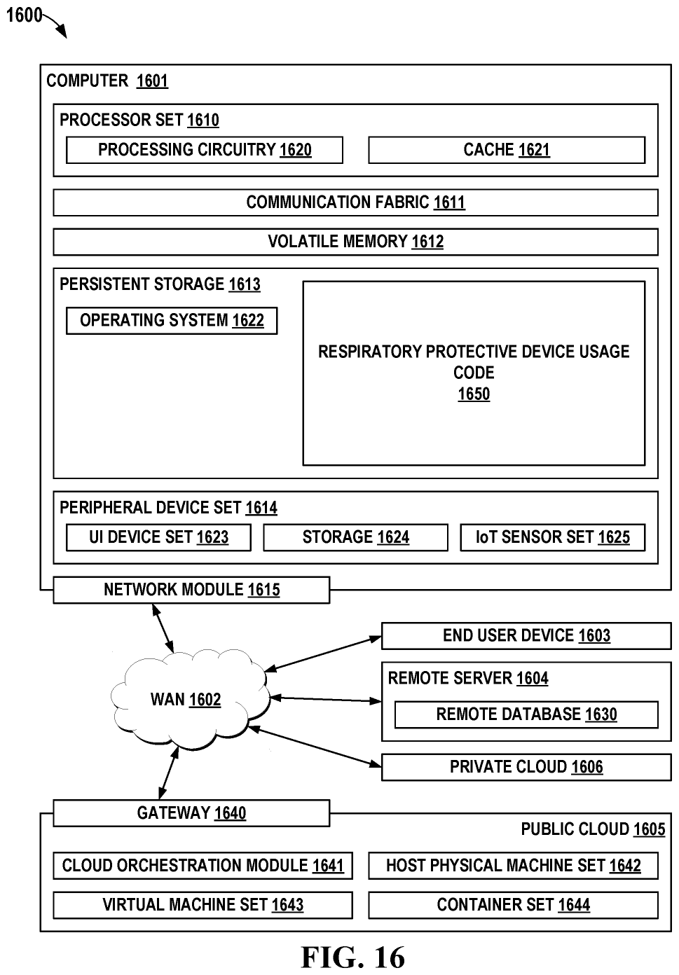

FIG. 16 illustrates an example of a computing system that may be communicatively linked to system 100 and that is configured to perform image processing and the various other operations described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1600 contains an example of an environment for the execution of at least some of the computer code involved in performing the inventive methods, such as respiratory protective device usage code illustrated in block 1650. The respiratory protective device usage code of block 1650 is capable of, upon execution, detecting whether users are wearing respiratory protective devices and/or are properly wearing respiratory protective devices. The respiratory protective device usage code of block 1650 uses optical tagging and image processing. The inventive methods performed with the computer code of block 1650 can, given IR images captured as described herein, perform operations such as those described in connection with FIGS. 3, 4, 5, and/or 7. In addition to block 1650, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1650, as identified above), peripheral device set 1614 (including user interface (UI) device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

COMPUTER 1601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1630. As is well understood in the art of computer technology, and depending upon the technology, performance of a computer-implemented method may be distributed among multiple computers and/or between multiple locations. On the other hand, in this presentation of computing environment 1600, detailed discussion is focused on a single computer, specifically computer 1601, to keep the presentation as simple as possible. Computer 1601 may be located in a cloud, even though it is not shown in a cloud in FIG. 16. On the other hand, computer 1601 is not required to be in a cloud except to any extent as may be affirmatively indicated.

PROCESSOR SET 1610 includes one, or more, computer processors of any type now known or to be developed in the future. Processing circuitry 1620 may be distributed over multiple packages, for example, multiple, coordinated integrated circuit chips. Processing circuitry 1620 may implement multiple processor threads and/or multiple processor cores. Cache 1621 is memory that is located in the processor chip package(s) and is typically used for data or code that should be available for rapid access by the threads or cores running on processor set 1610. Cache memories are typically organized into multiple levels depending upon relative proximity to the processing circuitry. Alternatively, some, or all, of the cache for the processor set may be located “off chip.” In some computing environments, processor set 1610 may be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, at least some of the instructions for performing the inventive methods may be stored in block 1650 in persistent storage 1613.

COMMUNICATION FABRIC 1611 is the signal conduction paths that allow the various components of computer 1601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory may be distributed over multiple packages and/or located externally with respect to computer 1601.

PERSISTENT STORAGE 1613 is any form of non-volatile storage for computers that is now known or to be developed in the future. The non-volatility of this storage means that the stored data is maintained regardless of whether power is being supplied to computer 1601 and/or directly to persistent storage 1613. Persistent storage 1613 may be a read only memory (ROM), but typically at least a portion of the persistent storage allows writing of data, deletion of data and re-writing of data. Some familiar forms of persistent storage include magnetic disks and solid-state storage devices. Operating system 1622 may take several forms, such as various known proprietary operating systems or open-source Portable Operating System Interface type operating systems that employ a kernel. The code included in block 1650 typically includes at least some of the computer code involved in performing the inventive methods.

PERIPHERAL DEVICE SET 1614 includes the set of peripheral devices of computer 1601. Data communication connections between the peripheral devices and the other components of computer 1601 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1623 may include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 may be persistent and/or volatile. In some embodiments, storage 1624 may take the form of a quantum computing storage device for storing data in the form of qubits. In embodiments where computer 1601 is required to have a large amount of storage (e.g., where computer 1601 locally stores and manages a large database) then this storage may be provided by peripheral storage devices designed for storing very large amounts of data, such as a storage area network (SAN) that is shared by multiple, geographically distributed computers. IoT sensor set 1625 is made up of sensors that can be used in Internet of Things applications. For example, one sensor may be a thermometer and another sensor may be a motion detector.

NETWORK MODULE 1615 is the collection of computer software, hardware, and firmware that allows computer 1601 to communicate with other computers through WAN 1602. Network module 1615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1615 are performed on the same physical hardware device. In other embodiments (e.g., embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1603 is any computer system that is used and controlled by an end user (e.g., a customer of an enterprise that operates computer 1601), and may take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 may be a client device, such as thin client, heavy client, mainframe computer, desktop computer and so on.

REMOTE SERVER 1604 is any computer system that serves at least some data and/or functionality to computer 1601. Remote server 1604 may be controlled and used by the same entity that operates computer 1601. Remote server 1604 represents the machine(s) that collect and store helpful and useful data for use by other computers, such as computer 1601. For example, in a hypothetical case where computer 1601 is designed and programmed to provide a recommendation based on historical data, then this historical data may be provided to computer 1601 from remote database 1630 of remote server 1604.

PUBLIC CLOUD 1605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1605 is performed by the computer hardware and/or software of cloud orchestration module 1641. The computing resources provided by public cloud 1605 are typically implemented by virtual computing environments that run on various computers making up the computers of host physical machine set 1642, which is the universe of physical computers in and/or available to public cloud 1605. The virtual computing environments (VCEs) typically take the form of virtual machines from virtual machine set 1643 and/or containers from container set 1644. It is understood that these VCEs may be stored as images and may be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware, and firmware that allows public cloud 1605 to communicate through WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1606 is similar to public cloud 1605, except that the computing resources are only available for use by a single enterprise. While private cloud 1606 is depicted as being in communication with WAN 1602, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1605 and private cloud 1606 are both part of a larger hybrid cloud.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving one or more infrared images of a user;
detecting, using image processing circuitry, an optical tag within the one or more infrared images, wherein the optical tag is disposed on a respiratory protective device; and
in response to detecting the optical tag within the one or more infrared images, generating a notification indicating that the user is wearing the respiratory protective device.

2. The method of claim 1, wherein the one or more infrared images are captured using a visible light blocking filter.

3. The method of claim 1, further comprising:
detecting, using image processing, eyes of the user within the one or more infrared images;
determining a distance between the optical tag and the eyes of the user within the one or more infrared images;
comparing the distance with a threshold distance; and
wherein the notification indicates whether the respiratory protective device is covering a nose of the user based on the comparing.

4. The method of claim 3, further comprising:
measuring an interpupillary distance between the eyes in the one or more infrared images; and
determining the threshold distance based on the interpupillary distance.

5. The method of claim 3, wherein the distance is measured from an interpupillary line.

6. The method of claim 3, further comprising:
in response to determining that the distance does not exceed the threshold distance, determining that the respiratory protective device covers the nose of the user, wherein the notification indicates that the respiratory protective device is worn properly by the user.

7. The method of claim 3, further comprising:
in response to determining that the distance exceeds the threshold distance, determining that the respiratory protective device does not cover the nose of the user, wherein the notification indicates that the respiratory protective device is not worn properly by the user.

8. The method of claim 3, wherein the one or more infrared images include:
a first infrared image captured using an on-axis infrared light source; and
a second infrared image captured using off-axis infrared light source.

9. The method of claim 8, wherein the detecting eyes of the user is performed, at least in part, by taking a difference between the first infrared image and the second infrared image.

10. The method of claim 1, further comprising:
determining respiratory protective devices usage among a plurality of users based, at least in part, on detected optical tags; and
detecting duplicate respiratory protective devices among the plurality of users based on detecting unique codes embedded in the optical tags.

11. A system, comprising:
an infrared camera configured to capture one or more infrared images of a user;
an image processing circuitry coupled to the infrared camera, wherein the image processing circuitry is configured to perform operations including:
detecting an optical tag within the one or more infrared images, wherein the optical tag is disposed on a respiratory protective device; and
in response to detecting the optical tag within the one or more infrared images, generating a notification indicating that the user is wearing a respiratory protective device.

12. The system of claim 11, wherein the one or more infrared images are captured using a visible light blocking filter.

13. The system of claim 11, wherein the image processing circuitry is configured to perform operations including:
detecting eyes of the user within the one or more infrared images;
determining a distance between the optical tag and the eyes of the user within the one or more infrared images;
comparing the distance with a threshold distance; and
wherein the notification indicates whether the respiratory protective device is covering a nose of the user based on the comparing.

14. The system of claim 13, wherein the image processing circuitry is configured to perform operations including:
measuring an interpupillary distance between the eyes in the one or more infrared images; and
determining the threshold distance based on the interpupillary distance.

15. The system of claim 13, wherein the distance is measured from an interpupillary line.

16. The system of claim 13, wherein the image processing circuitry is configured to perform operations including:
in response to determining that the distance does not exceed the threshold distance, determining that the respiratory protective device covers the nose of the user, wherein the notification indicates that the respiratory protective device is worn properly by the user.

17. The system of claim 13, wherein the image processing circuitry is configured to perform operations including:
in response to determining that the distance exceeds the threshold distance, determining that the respiratory protective device does not cover the nose of the user, wherein the notification indicates that the respiratory protective device is not worn properly by the user.

18. The system of claim 13, wherein the one or more infrared images include:
a first infrared image captured using on-axis infrared light source; and
a second infrared image captured using off-axis infrared light source.

19. The system of claim 18, wherein the detecting eyes of the user is performed, at least in part, by taking a difference between the first infrared image and the second infrared image.

20. A computer program product comprising one or more computer readable storage media having program instructions embodied therewith, the program instructions executable by a processor to cause the processor to initiate executable operations comprising:
receiving one or more infrared images of a user;
detecting an optical tag within the one or more infrared images, wherein the optical tag is disposed on a respiratory protective device; and
in response to detecting the optical tag within the one or more infrared images, generating a notification indicating that the user is wearing a respiratory protective device.
